(19) United States
(12) Patent Application Publication
(10) Pub. No.: US 2009/0274314 A1
(43) Pub. Date: Nov. 5, 2009

(54) METHOD AND APPARATUS FOR DETERMINING A DEGREE OF CLOSURE IN HEARING DEVICES

(76) Inventors: Georg-Erwin Arndt, Obermichelbach (DE); Dirk Junius, Langensendelbach (DE); Kristin Rohrseitz, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/432,058

(22) Filed: Apr. 29, 2009

(30) Foreign Application Priority Data
Apr. 30, 2008 (DE) 102008021613.5

(51) Int. Cl. H04R 29/00

(52) U.S. Cl. 381/60

(57) ABSTRACT

A method for determining a degree of closure in a hearing device with at least one auditory canal microphone, at least one receiver and an associated hearing device apparatus is disclosed. The method is characterized by an in-situ measurement of a transmission function between the receiver and the auditory canal microphone, by a comparison of the measured transmission function with previously determined reference values and/or curves, and by a determination of an effective vent diameter from the comparison, the effective vent diameter specifying the degree of closure.

### CROSS REFERENCE TO RELATED APPLICATIONS

This application claims priority of German Patent Application No. 10 2008 021 613.5 DE filed Apr. 30, 2008, which is incorporated by reference herein in its entirety.

### FIELD OF INVENTION

The invention relates to a method for determining a degree of closure in a hearing device and a hearing device for determining a degree of closure.

### BACKGROUND OF INVENTION

To accommodate the aesthetic requirements of a wearer of a hearing device, said hearing device is to be as inconspicuous as possible on the wearer from the outside. The miniaturization of the hearing devices thus necessary on the one hand and as versatile a functional range as possible on the other hand as well as a high-quality processing of the signals needed to improve the audibility within the hearing devices represent different requirements.

With hearing devices, a closure effect, the so-called occlusion, which is perceived by the wearer as unpleasant, may occur, since the space for a pressure equalization hole, the so-called vent, is frequently not sufficiently large. As a result of this closure effect, the actual voice of the hearing device wearer sounds louder and hollow. The occlusion effect takes place for instance by means of an in-the-ear hearing device inserted into the ear or by means of an otoplastic of a behind-the-ear hearing device.

Vents with a diameter of up to 1 mm are almost exclusively used to equalize the pressure when inserting an in-the-ear hearing device into the ear and/or into a part of the hearing device to be inserted into the ear. These small vents are also used to equalize the pressure in the case of temporally short pressure fluctuations in the surroundings, like for instance may occur in an aeroplane, when closing doors, in an elevator or when swallowing. Vents with a larger diameter have a huge influence on the low tone frequency path, but nevertheless also reduce the occlusion effect in the auditory canal, if the hearing device is positioned in the ear or on the auricle and therefore at least partially blocks the outer auditory canal.

All bores and channels in a hearing device are to be regarded acoustically as “long tubes” and exhibit low pass characters, i.e. they may allow low frequencies to “escape”. Bores with a larger diameter have greater cut-off frequencies and a more minimal damping. In this way a necessary sound separation function between a receiver of the hearing device or a radiating sound tube and an ambient microphone can however no longer be fulfilled in the vicinity of the ear from a certain acoustic amplification, as a result of which acoustic feedback occurs, a “whistling”. This acoustic feedback also depends on the diameter of the vent.

To measure the degree of occlusion, an open loop gain measurement can be implemented for instance as in the patent application DE 10 2006 042 083 A1. With this, the open loop amplification is determined by way of the frequency between a receiver and a microphone, which rests against the side facing away from the auditory path and is compared with stored reference curves.

To counteract the occlusion, the acoustic feedback but also other acoustic problems in the case of a hearing device, methods and apparatuses are known, which record the acoustic conditions in the exterior auditory canal using an auditory canal microphone and make a signal processing available within the hearing aid device. The patent application DE 10 2006 047 965 A1 specifies a method in this regard. The sensation of occlusion in the case of a hearing device wearer can be reduced with the aid of this active occlusion reduction despite a small vent diameter. In order to adjust the active occlusion reduction to the acoustics of the individual auditory canal of the hearing device wearer, an initialization measurement must be carried out on the ear of the wearer. This measurement is to indicate the effectiveness of the occlusion reduction. Due to the complexity and the depth of incoming measurement data, an appropriate interpretation by means of a hearing device acoustician is difficult and/or not possible, since the knowledge needed for the active occlusion reduction is understandably not available to him/her.

### SUMMARY OF INVENTION

An object of the invention is to specify a method and an apparatus, with which an interpretation of the initialization measurement, in particular for a hearing device acoustician, is easily possible.

In accordance with the invention, the set object is achieved with a method and a hearing device as claimed in the claims.

The object is achieved by a method for determining a degree of closure in a hearing device comprising at least one auditory canal microphone and at least one receiver. The method includes an in-situ measurement of a transmission function between the receiver and the auditory microphone, a comparison of the measured transmission function with previously determined reference values and/or curves and a determination of an effective vent diameter from the comparison, with the effective vent diameter specifying the degree of closure. The previously determined reference values and/or reference curves may have been determined theoretically or empirically for instance. This is advantageous in that a very apparent and easily interpretable variable, namely the effective vent diameter, is available instead of a very abstract result of an initialization measurement. This is also understandable for a hearing device acoustician.

In a further embodiment, the hearing device may comprise active occlusion suppression. A transmission function with switched-off active occlusion suppression can be measured, the measured transmission function can be compared with a maximum effect of the active occlusion suppression and a theoretical, maximally effective vent diameter can be determined from the comparison. As a result, it is possible to determine which maximum improvement is theoretically possible by means of active occlusion suppression.

In one development, the hearing device may include an active occlusion suppression, a first transmission function with a switched-off active occlusion suppression and a second transmission function with a switched-on active occlusion suppression can be measured, a first and a second effective vent diameter can be determined, the first can be compared with the second effective vent diameter and a quality factor of the active occlusion suppression can be determined from the comparison. This is advantageous in that active occlusion suppression can be evaluated easily.

A quality measure of the active occlusion suppression can preferably be determined from a comparison of the theoretical, maximally effective vent diameter using the second effective vent diameter. This determines the scope in which active occlusion suppression can in practice achieve its theoretical effects.

In a further embodiment, the hearing device can be switched to implementing the in-situ measurement and determining an effective vent diameter in a measuring mode. Outer influences are as a result eliminated.

The effective vent diameter for information and/or documentation can also be output by way of a hearing device interface. The value is thus easily accessible for a hearing device acoustician for instance.

In a further embodiment, the method can be exclusively implemented with means of the hearing device. This is advantageous in that no additional measuring devices are needed.

A hearing device for determining a degree of closure with at least one auditory canal microphone and at least one receiver is also specified, with the hearing device including a control and storage unit for implementing the method, with the receiver and the auditory canal microphone being linked to the control and storage unit.

In one development, acoustic measuring signals can be output by the receiver.

In a further embodiment, the acoustic measuring signals output by the receiver and/or reflected in the auditory canal can be recorded by the auditory canal microphone.

### BRIEF DESCRIPTION OF THE DRAWINGS

Further details and advantages of the invention are apparent from the explanations below of several exemplary embodiments with reference to schematic drawings, in which:

FIG. 1: shows a block diagram of an in-the-ear hearing device,

FIG. 2: shows a flow chart of a method for determining an effective vent diameter,

FIG. 3: shows a flow chart of a method for determining a quality factor and

FIG. 4: shows a transmission curve.

### DETAILED DESCRIPTION OF INVENTION

The key components of hearing devices are principally an input converter, an amplifier and an output converter. The input converter is normally a receiving transducer e.g. a microphone and/or an electromagnetic receiver, e.g. an induction coil. The output converter is most frequently realized as an electroacoustic converter e.g. a miniature loudspeaker, or as an electromechanical converter e.g. a bone conduction hearing aid. The amplifier is usually integrated into a signal processing unit.

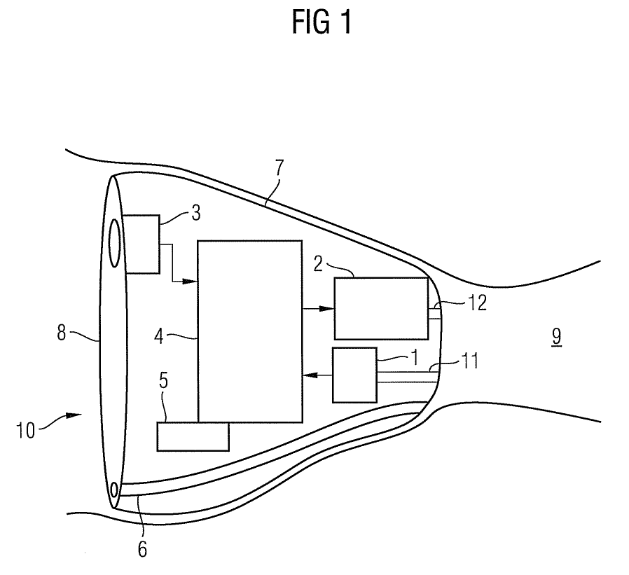

This basic configuration is illustrated in FIG. 1 using the example of a behind-the-ear hearing device 10. A microphone 3 for recording ambient sound, a control and storage unit 4 with a signal processing unit (not shown), a receiver 2 and an auditory canal microphone 1, are built into a hearing device housing 7 to be worn in the ear. A battery 5 powers the electrical components of the hearing device 10. The output of the microphone 3 is connected to an input of the control and storage unit 4. The processed microphone signals are provided at an output of the control and storage unit 4 and fed to the receiver 2. The thus amplified acoustic signals reach the exterior auditory canal 9 by way of a hearing channel 12. Acoustic signals reflected in the auditory canal 9 and from the auditory canal microphone 1 are fed to the auditory canal microphone 1 by way of a microphone channel 11. The converted acoustic signals reach an input of the control and storage unit 4 from an output of the auditory canal microphone 1. The acoustic signals received by the auditory canal microphone 1 are used in the control and storage unit 4 to control the active occlusion suppression. A vent 6, also referred to as a ventilation channel, ensures pressure equalization when inserting the in-the-ear hearing device 10 into the ear. The vent 6 also reduces the occlusion sensation of a hearing device wearer. The hearing device 10 is closed in a tight fashion on the side facing away from the ear drum by means of a front plate 8.

In the case of an inserted hearing device, measuring signals and/or measuring signal sequences are emitted by the receiver 2 into the auditory canal 9 in order to determine a degree of closure in the in-the-ear hearing device 10. These measuring acoustic signals are reflected in the auditory canal 9 and on the eardrum and then reach the auditory canal microphone 1. The control and storage unit 4 evaluates these measuring signals received by the auditory canal microphone 1 by determining a transmission function from the measuring signals received by the auditory canal microphone 1 and comparing these with stored reference transmission functions and/or reference values. The control and storage unit 4 calculates an effective vent diameter EV from this comparison. The effective vent diameter EV is a theoretical measure for the occlusion suppression. It specifies how large the diameter of a physical vent has to be in order to generate the same occlusion suppression effect. The reference data stored in the control and storage unit 4 was either determined theoretically or originates from empirical examinations and/or measurements.

Effective vent diameters EV can be determined with or without switched-on active occlusion suppression.

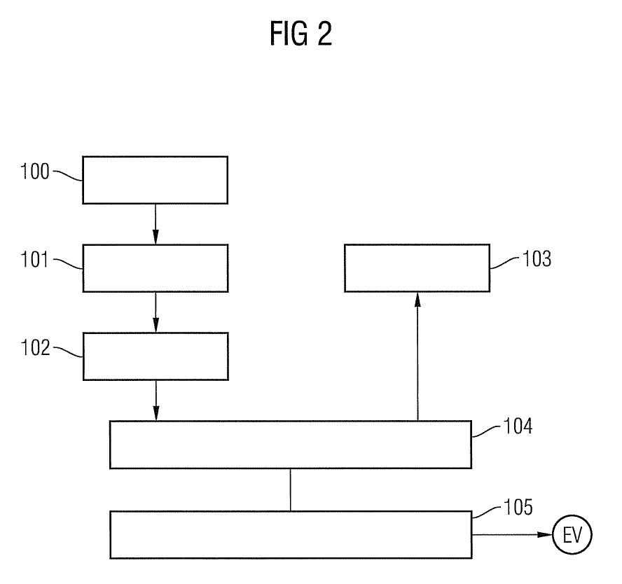

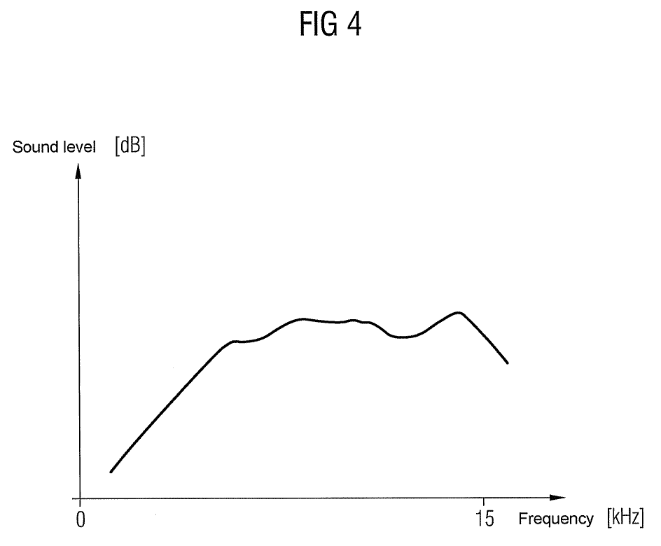

FIG. 2 shows a method for determining a degree of closure of a hearing device comprising at least one auditory canal microphone and at least one receiver in a flow chart. A hearing device is switched into measuring mode in step 100. The hearing device is then inserted into the auditory canal in step 101. An in-situ measurement of a transmission function takes place between the receiver and the auditory canal in step 102. The measured transmission function is stored in a control and storage unit and is compared in step 104 with previously determined reference values and/or reference curves 103. An effective vent diameter EV is determined in step 105 from the comparison. The effective vent diameter EV is a measure for the degree of closure. The measured transmission function indicates a high pass characteristic, in other words that low frequencies are more significantly damped than higher frequencies. FIG. 4 shows an example of a measured transmission function with a high pass characteristic.

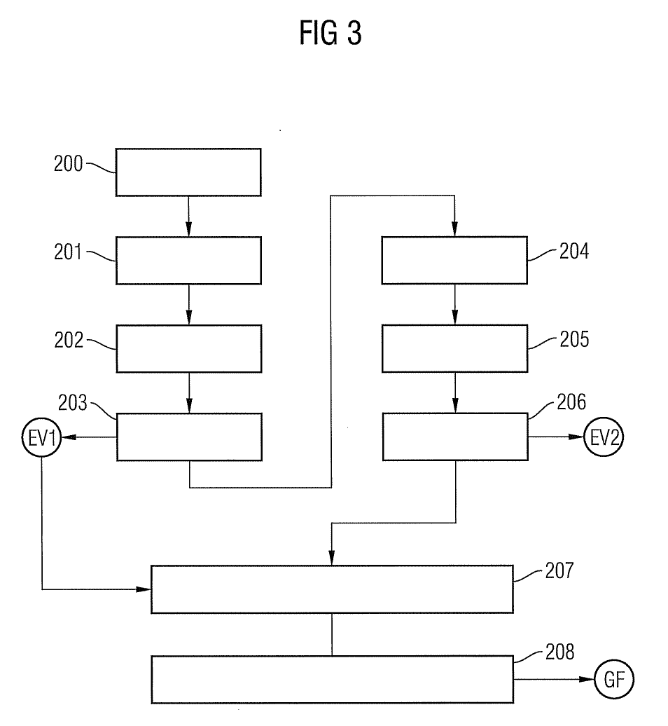

A flow chart of an additional method is shown in FIG. 3. A hearing device is moved into a measuring mode in step 200 and is inserted into an auditory canal of a hearing device wearer in step 201. A first in-situ measurement of a transmission function between the receiver and the auditory canal microphone takes place in step 202. A first effective vent diameter EV1 is then determined from a comparison of the transmission functions obtained with the first in-situ measurement with the previously determined reference values and/or reference curves. The active occlusion suppression is then switched on in step 204 and a second in-situ measurement takes place in step 205. A second transmission function between the receiver and the auditory canal microphone is determined here. A second effective vent diameter EV2 is determined in step 206 from the result of the second in-situ measurement. The determination likewise takes place by way of a comparison of the second measured transmission function with previously determined reference values and/or reference curves. The first effective vent diameter EV1 and the second effective vent diameter EV2 are compared with one another in step 207. A quality factor GF is determined from the comparison in step 208 with the aid of a computing algorithm, said quality factor being a measure for the effect of the active occlusion suppression.

1.-11. (canceled)

12. A method for determining a degree of closure in a hearing device having an auditory canal microphone and a receiver, comprising:
in-situ measuring of a transmission function between the receiver and the auditory canal microphone;
comparing the measured transmission function with previously determined reference values or reference curves; and
determining an effective vent diameter based upon the comparing, wherein the effective vent diameter specifies the degree of closure.

13. The method as claimed in claim 12, wherein the measured transmission function is compared with previously determined reference values and reference curves.

14. The method as claimed in claim 12, wherein the hearing device includes an active occlusion suppression.

15. The method as claimed in claim 14, wherein the transmission function is measured with a switched-off active occlusion suppression, wherein the measured transmission function is compared with a maximum effect of the active occlusion suppression and a theoretical, maximally effective vent diameter is determined from the comparison.

16. The method as claimed in claim 14, further comprising:
in-situ measuring a first transmission function with a switched-off active occlusion suppression;
in-situ measuring a second transmission function with a switched-on active occlusion suppression;
determining a first effective vent diameter;
determining a second effective vent diameter;
comparing the first effective vent diameter with the second effective vent diameter; and
determining a quality factor of the active occlusion suppression based upon the comparing.

17. The method as claimed in claim 16, wherein a quality measure of the active occlusion suppression is determined from a comparison of a theoretical, maximally effective vent diameter with the second effective vent diameter.

18. The method as claimed in claim 12, wherein the hearing device is switched into a measuring mode in order to implement the in-situ measurement and the determination of the effective vent diameter.

19. The method as claimed in claim 12, wherein the effective vent diameter is output for information via a hearing device interface.

20. The method as claimed in claim 12, wherein the effective vent diameter is output for a documentation via a hearing device interface.

21. The method as claimed in claim 12, wherein the method is exclusively implemented by the hearing device.

22. A computer readable medium encoded with instructions that, when executed in a control unit of a hearing device having an auditory canal microphone and a receiver, performs a method, comprising:
in-situ measuring of a transmission function between the receiver and the auditory canal microphone;
comparing the measured transmission function with previously determined reference values or reference curves; and
determining an effective vent diameter based upon the comparing, wherein the effective vent diameter specifies the degree of closure.

23. The method as claimed in claim 22, wherein the measured transmission function is compared with previously determined reference values and reference curves.

24. A hearing device for determining a degree of closure, comprising:
an auditory canal microphone;
a receiver; and
a control and storage unit, the auditory canal microphone and the receiver being electrically connected to the control and storage unit, wherein the control and storage unit is configured to perform a method, comprising
in-situ measuring of a transmission function between the receiver and the auditory canal microphone;
comparing the measured transmission function with previously determined reference values or reference curves; and
determining an effective vent diameter based upon the comparing, wherein the effective vent diameter specifies the degree of closure.

25. The method as claimed in claim 24, wherein the measured transmission function is compared with previously determined reference values and reference curves.

26. The hearing device as claimed in claim 24, wherein acoustic measuring signals are emitted by the receiver.

27. The hearing device as claimed in claim 26, wherein the acoustic measuring signals output by the receiver or reflected acoustic measuring signals in the auditory canal are received by the auditory canal microphone.
